(19) United States
(12) Patent Application Publication
(10) Pub. No.: US 2011/0175715 A1
(43) Pub. Date: Jul. 21, 2011

(54) TIRE PRESSURE MONITORING SYSTEM SENSOR ASSOCIATION INDICATOR

(76) Inventors: Steven Schondorf, Dearborn, MI (US); Dilip Patel, Novi, MI (US); Brian Bennie, Sterling Heights, MI (US); Greg Swadling, Milford, MI (US); Fred Gaynier, Livonia, MI (US)

(21) Appl. No.: 12/690,235

(22) Filed: Jan. 20, 2010

(51) Int. Cl. B60C 23/02

(52) U.S. Cl. 340/442

(57) ABSTRACT

A system and method of manually associating, in a predetermined order, each sensor in a plurality of sensors used by a tire pressure monitoring system with a corresponding wheel location on a vehicle comprising, activating an indicator at a first location, associating a first sensor for the first location in the tire pressure monitoring system, activating an indicator at a subsequent location, associating a subsequent sensor for the subsequent location in the tire pressure monitoring system, and repeating the steps of activating and associating for each sensor in the plurality of sensors.

### TECHNICAL FIELD

The invention relates generally to a tire pressure monitoring system for an automotive vehicle, and more particularly to a method and system for associating a sensor's identification to a correct tire location on a vehicle.

### BACKGROUND

Direct tire pressure monitoring systems (TPMS) utilize sensors in each wheel to actively monitor tire pressure. The data transmitted by the sensor includes a unique sensor identification number, also called a sensor ID. For proper operation, the sensor ID's must be associated to a specific tire location on the vehicle. This occurs at the manufacturing site. However, in the event tires are rotated, a tire is replaced, or a new tire sensor is installed on the vehicle, the sensor ID's must be manually re-associated with the vehicle by the driver, or a service technician.

Re-association must be performed in a specific order on the vehicle to ensure proper monitoring of tire pressures by the TPMS. This is particularly important for vehicles known to be split-placard where the front and rear recommended tire pressures are different and for vehicles that provide location specific tire pressure data.

The particular order for re-association is spelled out in an owner's manual or a service manual. However, in some cases, the order may not be followed by the customer or service technician. The result is incorrect operation of the TPMS which leads to customer dissatisfaction. It would therefore be desirable to provide a system and method for manually associating TPMS sensor ID's to a vehicle in the correct order and location that involves vehicle initiated signals that are visually or audibly recognized by the customer or technician.

### SUMMARY

One aspect of the invention is a method of manually associating, in a predetermined order, each sensor in a plurality of sensors used by a tire pressure monitoring system with a corresponding wheel location on a vehicle comprising the steps of activating an indicator at a first location, associating a first sensor for the first location in the tire pressure monitoring system, activating an indicator at a subsequent location, associating a subsequent sensor for the subsequent location in the tire pressure monitoring system, and repeating the steps of activating and associating for each sensor in the plurality of sensors.

Another aspect of the invention is a system for manually associating, in a predetermined order, each sensor in a plurality of sensors used by a tire pressure monitoring system with a corresponding wheel location on a vehicle comprising a controller, a plurality of lamps coupled to the controller, each lamp being positioned in proximity to a wheel location of the vehicle, a plurality of tire pressure sensors coupled to the controller, each tire pressure sensor being position in a tire at each wheel location of the vehicle, the controller activating an indicator at a first location, associating a first sensor for the first location in the tire pressure monitoring system, activating an indicator at a subsequent location, associating a subsequent sensor for the subsequent location in the tire pressure monitoring system, and repeating the steps of activating and associating for each subsequent sensor in the plurality of sensors with a subsequent location.

Still another aspect of the invention is a method for manually associating, in a predetermined order, each sensor in a plurality of sensors used by a tire pressure monitoring system with a corresponding wheel location on a vehicle comprising the steps of activating an indicator at a front left tire location, associating a front left tire pressure sensor to the front left tire location in the tire pressure monitoring system, activating an indicator at a front right tire location, associating a front right tire pressure sensor to the front left tire location in the tire pressure monitoring system, activating an indicator at a rear right tire location, associating a rear right tire pressure sensor to the rear right tire location in the tire pressure monitoring system, activating an indicator at a rear left tire location, associating a rear left tire pressure sensor to the rear left tire location in the tire pressure monitoring system, and displaying a system status.

### DESCRIPTION OF DRAWINGS

FIG. 1 is a vehicle having a lighting and a tire pressure monitoring system (TPMS);

FIG. 2 is a diagrammatic view of a pressure sensor circuit;

FIG. 3 is a word generated by the tire pressure sensor circuit shown in FIG. 2; and

FIG. 4 is a flow diagram of the present invention.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DESCRIPTION OF INVENTION

While various aspects of the present invention are described with reference to a particular illustrative embodiment, the invention is not limited to such embodiments, and additional modifications, applications, and embodiments may be implemented without departing from the present invention. In the figures, like reference numbers will be used to illustrate the same components. Those skilled in the art will recognize that the various components set forth herein may be altered without varying from the scope of the inventive subject matter.

FIG. 1 shows a vehicle 10 having a lighting system that includes an indicator lamp 12a, 12b, 12c, and 12d at each of the left front, right front, right rear and left rear wheel locations. The lamps 12a-d are coupled to a controller 14 and are typically associated with a turn signal system on the vehicle 10 whereby a vehicle operator will initiate a signal to illuminate the lamps associated with the direction the operator intends to turn the vehicle. The vehicle 10 also has a tire pressure monitoring system (TPMS). The TPMS is for monitoring the air pressure within a left front tire 16a, a right front tire 16b, a right rear tire 16c, and a left rear tire 16d. Each tire 16a-16d has a respective tire pressure sensor circuit 18a, 18b, 18c and 18d. Each tire 16a-d is positioned upon a corresponding wheel.

Controller 14 is preferably a microprocessor based controller having a programmable CPU that may be programmed to perform various functions and processes including those set forth herein. Controller 14 has a memory 20 associated therewith. Memory 20 may be various types of memory including ROM or RAM. Memory 20 is illustrated as a separate component. However, those skilled in the art will recognize controller 14 may have memory 20 therein. Memory 20 is used to store various thresholds, calibrations, tire characteristics, wheel characteristics, serial numbers, conversion factors, temperature probes, spare tire operating parameters and other values needed in the calculation, calibration and operation of the TPMS. For example, memory may contain a table that includes the sensor identification thereof. Also the warning statuses of each of the tires may also be stored within the table, e.g. temperature status, pressure status, and motion status just to name a few examples of what may be considered a warning status.

Controller 14 is coupled to the plurality of pressure sensor circuits 18a-d. In processing, the controller 14 receives data such as sensor status pressure and sensor ID and links the data to the TPMS.

A telemetric system 22 may be used to communicate information to and from a central location on the vehicle. For example, the central location may keep track of service intervals and use and inform the vehicle operator service is required. A display in the vehicle, such as on the instrument panel, may be used to visually inform the vehicle operator of any messages.

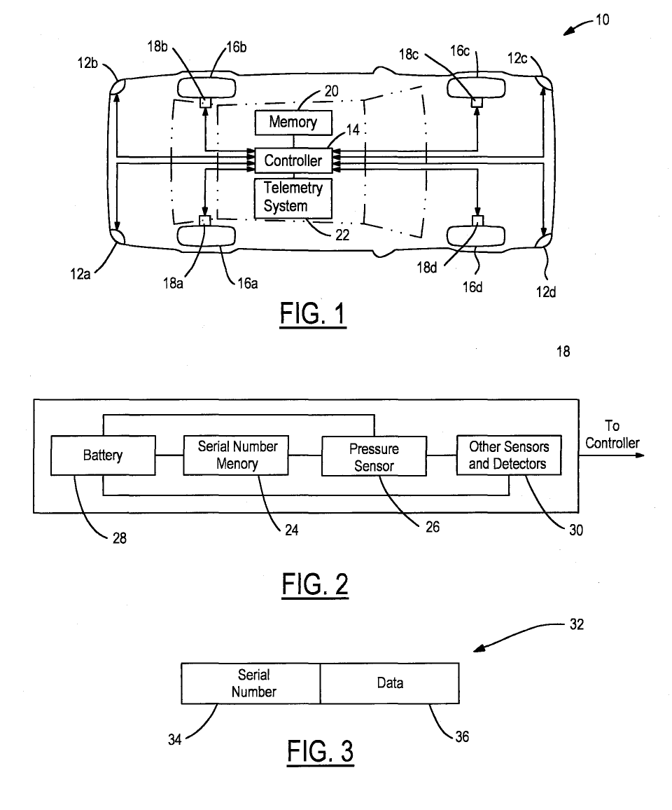

FIG. 2 is a diagrammatic view of a pressure sensor circuit 18. Only one tire pressure sensor circuit is shown, and each may be commonly configured and contained within a tire pressure sensor. Each pressure sensor circuit 18 has information such as a serial number memory 24 for storing a unique serial number identification an, a pressure sensor 26 for determining the pressure within the tire. Each of the serial number memory 24 and pressure sensor 26 are coupled to a battery 28. Battery 28 is preferably a long life battery capable of lasting through the life of the tire. Other sensors and detectors 30 may also be coupled to the battery. Other sensors in the sensor circuit may include, but are not limited to, temperature, and a motion detector.

FIG. 3 is a word 32 generated by the tire pressure sensor circuit 18 shown in FIG. 2. Word 32 may comprise an identification serial number portion 34 followed by a data portion 36 in a predetermined format. For example, data section 36 may include initial status pressure information followed by other information such as temperature, etc. The word 32 is preferably such that it may be decoded by the controller in order to validate the word, provide the identification or serial number of each sensor, the pressure, temperature, and sensor function for each tire at each wheel location respectively.

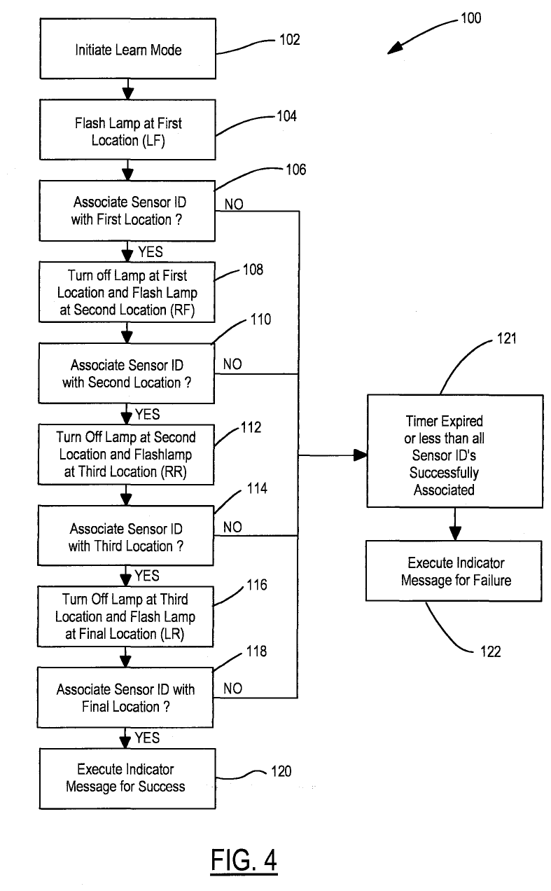

FIG. 4 is a flow diagram of the present invention which is a method 100 for manually associating TPMS sensor ID's to a vehicle in the correct location and order. The example shown in FIG. 4 is for four locations and four sensor ID's. One skilled in the art is capable of modifying the method, without departing from the scope of the present invention, to accommodate more or fewer locations. The operator initiates 102 a learn mode in the controller. Upon initiation of the learn mode, a timer is started for a predetermined period of time during which the operator has the ability to associate the sensors at each tire location to the TPMS. An alarm or signal may be provided to alert the operator that the predetermined timer period for association has begun. Such alarm or signal may be visual, audible or both. For example, a message may be provided on a display in the vehicle such as the telemetric system, the headlamps or turn signal lamps may flash and/or horn chirp or other alarm or bell may be provided from the vehicle.

After the learn mode is initiated, the lamp at the first tire location to be associated with a sensor begins flashing 104 as an indication of the starting point for association. A horn chirp or other audible signal may accompany the flashing lamp to indicate that the timer is timing. In this particular example the first location is the left front indicator lamp. The flashing lamp indicates to the operator the starting point for associating the sensor ID during the learn mode. The operator then associates 106 the left front tire pressure sensor with the left front tire location in any manner known to be applicable to the particular vehicle and tire pressure monitoring system associated therewith. Once the sensor is properly associated the left front indicator lamp is turned off and the right front indicator lamp begins to flash 108, thereby indicating to the operator, the second location to be associated. Again, an audible signal may accompany the flashing lamp. Likewise, upon association of the second sensor with the second location 110, the right front indicator lamp is turned off and the right rear lamp is turned on 112. The right rear lamp will flash until the operator has completed the association 114 of the third sensor with the third location, at which point in time, the right rear lamp is turned off and the left rear lamp will flash 116. When the left rear sensor has been associated with the left rear tire location the association mode is complete 118.

Upon completion of the association mode, the system will display a status message thereby indicating to the operator the success 120, or failure 122, of the association mode process. If all sensors are identified, associated and true, a confirmation signal or message is provided by the controller from the vehicle. The confirmation signal may be displayed visually and/or an audible signal, such as a horn chirp, may be executed. In the event the timer expires before the locations are learned or the operator failed to properly associate each sensor with each location 121, an acknowledgement signal or message will be displayed to notify the operator that the learn mode has ended without the sensors being associated with their proper location, such as “tires not learned”. An audible signal may also be executed upon failure to learn tire locations. The acknowledgement signal indicating failure may be distinct from the confirmation signal associated with a successful association mode. For example, a successful association mode may end with a single horn chirp while a failed association mode may end with a double horn chirp.

An advantage of the present invention lies in the fact that the operator cannot misread, or fail to refer to, the operators manual when re-associating sensor ID's and tire locations. The present invention improves customer satisfaction by presenting a fail-safe manner for re-associating sensor ID's and ensuring correct operation of the TPMS. Additionally, the technician's job is made easier, thereby increasing job satisfaction.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A method of manually associating, in a predetermined order, each sensor in a plurality of sensors used by a tire pressure monitoring system with a corresponding wheel location on a vehicle comprising:
activating an indicator at a first location;
associating a first sensor for the first location in the tire pressure monitoring system;
activating an indicator at a subsequent location;
associating a subsequent sensor for the subsequent location in the tire pressure monitoring system;
repeating the steps of activating and associating for each sensor in the plurality of sensors.

2. A method as claimed in claim 1 wherein each indicator is a lamp on the vehicle in close proximity to a respective wheel location and activating the indicator is flashing the lamp.

3. A method as claimed in claim 1 wherein each step of activating an indicator further comprises an audible indicator.

4. A method as claimed in claim 1 further comprising the steps of:
providing a confirmation signal from the vehicle upon successful association of each sensor in the plurality of sensors; and
providing an acknowledgement signal from the vehicle upon failed association of at least one sensor in the plurality of sensors.

5. A method as claimed in claim 4 wherein the confirmation signal is visual and the acknowledgement signal is visual yet distinct from the confirmation signal.

6. A method as claimed in claim 4 wherein the confirmation signal is audible and the acknowledgement signal is audible yet distinct from the audible confirmation signal.

7. A method as claimed in claim 4 wherein the confirmation signal visual and audible and the acknowledgement signal is visual and audible yet distinct from the visual and audible confirmation signal.

8. A system for manually associating, in a predetermined order, each sensor in a plurality of sensors used by a tire pressure monitoring system with a corresponding wheel location on a vehicle comprising:
a controller;
a plurality of lamps coupled to the controller, each lamp being positioned in proximity to a wheel location of the vehicle;
a plurality of tire pressure sensors coupled to the controller, each tire pressure sensor being position in a tire at each wheel location of the vehicle;
the controller activating an indicator at a first location, associating a first sensor for the first location in the tire pressure monitoring system, activating an indicator at a subsequent location, associating a subsequent sensor for the subsequent location in the tire pressure monitoring system, and repeating the steps of activating and associating for each subsequent sensor in the plurality of sensors with a subsequent location.

9. A system as claimed in claim 8 further comprising:
a confirmation signal from the controller upon successful association of each sensor in the plurality of sensors; and
an acknowledgement signal from the controller upon failed association of at least one sensor in the plurality of sensors.

10. The system as claimed in claim 9 wherein the confirmation signal and the acknowledgement signal are visual yet distinct from one another.

11. The system as claimed in claim 9 wherein the confirmation signal and the acknowledgement signal are audible yet distinct from one another.

12. The system as claimed in claim 9 wherein the confirmation signal and the acknowledgment signal are each visual and audible yet distinct from one another.

13. A method for of manually associating, in a predetermined order, each sensor in a plurality of sensors used by a tire pressure monitoring system with a corresponding wheel location on a vehicle comprising:
activating an indicator at a front left tire location;
associating a front left tire pressure sensor to the front left tire location in the tire pressure monitoring system;
activating an indicator at a front right tire location;
associating a front right tire pressure sensor to the front left tire location in the tire pressure monitoring system;
activating an indicator at a rear right tire location;
associating a rear right tire pressure sensor to the rear right tire location in the tire pressure monitoring system;
activating an indicator at a rear left tire location;
associating a rear left tire pressure sensor to the rear left tire location in the tire pressure monitoring system; and
displaying a system status.

14. A method as claimed in claim 13 wherein each indicator is a lamp on the vehicle in close proximity to a respective wheel location and activating the indicator is flashing the lamp.

15. A method as claimed in claim 13 wherein each step of activating an indicator further comprises an audible indicator.

16. A method as claimed in claim 13 wherein displaying a system status further comprises the steps of:
providing a confirmation signal from the vehicle upon successful association of each sensor in the plurality of sensors; and
providing an acknowledgement signal from the vehicle upon failed association of at least one sensor in the plurality of sensors.

17. A method as claimed in claim 15 wherein the confirmation signal is visual and the acknowledgement signal is visual yet distinct from the confirmation signal.

18. A method as claimed in claim 15 wherein the confirmation signal is audible and the acknowledgement signal is audible yet distinct from the audible confirmation signal.

19. A method as claimed in claim 15 wherein the confirmation signal visual and audible and the acknowledgement signal is visual and audible yet distinct from the visual and audible confirmation signal.

20. A method as claimed in claim 13 wherein the step of displaying a system status further comprises displaying the system status upon expiration of a predetermined period of time that begins at the activation of the indicator at the front left tire location.
